(19) United States
(12) Patent Application Publication
(10) Pub. No.: US 2015/0329164 A1
(43) Pub. Date: Nov. 19, 2015

(54) Human Powered Land Vehicle

(71) Applicant: RECTICEL N. V., Brussels (BE)

(72) Inventors: Hugo de Winter, Wetteren (BE); Kris Bracke, Wetteren (BE); Michel Vermeulen, Drongen (BE)

(73) Assignee: RECTICEL N. V., Brussels (BE)

(21) Appl. No.: 14/650,832

(22) PCT Filed: Dec. 21, 2012
(86) PCT No.: PCT/EP2012/076772

§ 371 Date: Jun. 9, 2015

(51) Int. Cl. B62K 5/05; B62K 21/12; B62M 6/60; B62M 1/36

(52) U.S. Cl. CPC B62K 5/05; B62M 1/36; B62K 21/12; B62M 6/60

(57) ABSTRACT

A human powered land vehicle has two steered front wheels (3, 3.1) and at least one rear wheel (2) driven by a drive train. The drive train incorporates a human powered actuator (13) to be actuated for propulsion of the vehicle (1) by a person driving the vehicle (1). This actuator (13) is cinematically coupled to the rear wheel (2) for propulsing the vehicle in at least one driving direction. A first suggestion is defined—in that the axis A3 of the human powered actuator (13) is arranged in the longitudinal extension of the vehicle (1) in front of the axis A₁, A₁₁ of rotation of the front wheels (3, 3.1), —in that three dimensions are defined in the x-y plane of the vehicle, which are (a) a distance d1 between the centre B of rotation of the axis A₂ of the rear wheel (2) and the centre D of rotation of the axis A3 of the human powered actuator (13), (b) a distance d2 between the centre A of rotation of the axis (A1, A_{1.1}) of the front wheel (3, 3.1) and the intersection point C of a line connecting the centre A with the x-axis of the vehicle (1) the connecting line being perpendicular to the x-axis of the vehicle (1), and—(c) a distance d₃ between the centre B and the intersection point C, whereas distance d1 has a value of 1235 mm±15%, distance d2 has a value of 1 132 mm±15%, and distance d3 has a value of 379 mm±15% and—in that the ratio between the squared distance AB2 between the centre B and the centre A and the squared distance AD2 between the centre A and the centre D is within the range between 2.8 to 15.3. According to another suggestion the ratio of the distance of the front wheels (3, 3.1) from each other measured in the height of their axis A1, A1.1 of rotation and the diameter of the front wheels (3, 3.1) is in the range from about 1.3 to about 1.7. The axis A₃ of the human powered actuator (13) is arranged between the two front wheels (3, 3.1) within their projection to each other in the traverse direction of the vehicle (1) and in the vertical direction above the axis A1, A1.1 of rotation of the front wheels (3, 3.1) and in the longitudinal extension of the vehicle (1) in front of the axis of rotation of the front wheels (3, 3.1).

The invention is related to a human powered land vehicle with two steered front wheels and at least one rear wheel driven by a drive train, which drive train incorporates a human powered actuator to be actuated for propulsion of the vehicle by a person driving the vehicle and cinematically coupled to the rear wheel for propulsing the vehicle in at least one driving direction.

Land vehicles of this kind typically make use of a pedal drive as human powered actuator. Typically such pedal propulsed land vehicles are bicycles (pedal propulsed land vehicles with two wheels) or tricycles (pedal propulsed land vehicles with three wheels). Apart from the wheelchair-type vehicles, tricycles are three-wheeled bicycles, in which the driver usually is positioned in a laying-down position, similar to a two-wheel recumbent bicycle. Such tricycles typically have two front wheels and a rear wheel driven by the pedal drive. The front wheels of such a vehicle are steered. Such vehicles may comprise a cover, typically made of a flexible canvas or a rigid panel. Both versions of a cover may have a closed front provided with a windshield.

It is also known from prior art to additionally make use of a non-human powered actuator, typically an electric motor as an auxiliary drive for propulsing such vehicle. In DE 295 15 188 U1 such kind of a vehicle is disclosed comprising a pedal drive and an electric motor coupled to the axle of the rear wheel with a centrifugal clutch.

The pedal drive of such kind of prior art vehicle is linked with the driven rear wheel by way of a chain as driving means. The axis of the pedal drive driving the chain is arranged in the longitudinal direction of the vehicle well in front of the axis of rotation of the front wheels. As a consequence, these vehicles have a certain length, which may not be reduced. For easier handling of such a vehicle while driving, in particular when sharp curves are to be taken or when a parking slot is needed, a shorter vehicle would be preferred.

In particular for future urban mobility, light-weight human propulsed vehicles, are typically fitted with an auxiliary motor, are regarded as promising to provide the mobility needed and still save conventional fuels. Further, it is regarded as promising, if such kind of vehicles would be easy in handling and provide a certain comfort for the driver. The latter also involves, that it should be easy for the driver to enter and exit the vehicle. Easily handling should also involve, that the vehicle may be parked in small spaces and that therefore its overall length shall be kept rather small. In particular such a vehicle should on one hand not exceed a certain overall width but on the other hand still leave sufficient space for convenient sitting and actuating the human powered actuator.

In the light of the prior art sketched-out above and the objectives it is an object of the invention to provide a human powered land vehicle, which complies at least in part with the requirement set-out above.

This technical problem is solved by way of a human powered land vehicle as defined in the introductory part of claim 1,
in that the axis of the human powered actuator is arranged in the longitudinal extension of the vehicle in front of the axis of rotation of the front wheels,
in that three dimensions are defined in the x-y plane of the vehicle, which are
   (a) a distance d₁ between the centre B of rotation of the axis of the rear wheel and the centre D of rotation of the axis of the human powered actuator,
   (b) a distance d₂ between the centre A of rotation of the axis of the front wheel and the intersection point C of a line connecting the centre A with the x-axis of the vehicle the connecting line being perpendicular to the x-axis of the vehicle, and
   (c) a distance d₃ between the centre B and the intersection point C, whereas distance d₁ has a value of 1235 mm±15%, distance d₂ has a value of 1132 mm±15%, and distance d₃ has a value of 379 mm±15% and
   in that the ratio between the squared distance AB² between the centre B and the centre A and the squared distance AD² between the centre A and the centre D is within the range between 2.8 to 15.3.

This technical problem is further solved by way of a human powered land vehicle as defined in the preamble of claim 4, in that the ratio of the distance of the front wheels from each other measured in the height of their axis of rotation and the diameter of the front wheels is in the range from about 1.1 to about 1.9 and in that the axis of the human powered actuator is arranged between the two front wheels within their projection to each other in the traverse direction of the vehicle and in the vertical direction above the axis of rotation of the front wheels and in the longitudinal extension of the vehicle in front of the axis of rotation of the front wheels.

Using one of these concepts or even both concepts combined it is possible to design a human powered land vehicle, which may not only be designed to show a rather short length, but which in particular may be designed respecting the requirements as to light-weight, comfort, which involves enough comfort within the vehicle for the driver also in the direction of the width of the vehicle and effectiveness.

The concepts have in common, that certain geometrical relationships have been encountered to define a very specific arrangement of rotation axis of the rear wheel, the front wheels and the human powered actuator. The teachings of these concepts allow a person skilled in the art to design such human powered land vehicle, which meets the objectives sketched out above in a rather surprisingly simple manner.

According to the first concept the arrangement of the rear wheel to the two front wheels and the axis of the human powered actuator from a top view of the vehicle are described in a simple manner. The variables used in the ratio do not only define the simple distance between the respective axis of rotation but also imply other information as for example related to the width of the vehicle. First of all, it is suggested, that the axis of the human powered actuator is to be arranged in front of the axis of rotation of the front wheel when looking in a forward driving direction. Starting from such arrangement using two geometrical virtual triangles the dimensions of the vehicle may be expressed by the claimed ratio, if a vehicle is to be designed, which meets the objectives put down above. The two triangles are right-angled triangles, whereas one side of both triangles is identical and shared by each triangle. This side of both triangles is a line linking the centre of rotation of the axis of one front wheel as a perpendicular line to the central x-axis of the vehicle in a top view. Therefore, both triangles have this centre of axis of the front wheel as one corner and the intersection of said perpendicular line with the x-axis as second corner. The first triangle has its third corner in the centre of axis of rotation of the rear wheel, whereas the second triangle has it third corner at the centre of rotation of the human powered actuator. Due to the relation of the length of the sides of each triangle to their hypotenuse by using the distance claimed, which is the hypotenuse in each triangle, also the information concerning the overall length and the width of the vehicle is expressible and implemented in such ratio.

Further, the concept is kept simple, because it only uses distances between vehicle components which are easily accessible, two of which are a range on the x-axis of the vehicle. Taking mean values and defining a certain deviation thereof allows to define those vehicles, which virtually meet the requirement set out above. The minimum and maximum values of three distances and the ratio sketched out above being within a certain range very precisely define the human powered vehicle, which the invention aims to.

In a preferred embodiment the deviation of the mean distance values is restricted to ±10%. In another embodiment the deviation is limited to ±5%. It will well be understood, that then the vehicle will be more compact. This may be encountered individually or together with the before mentioned restricted deviation value, if said ratio range is limited to a range between 6.0 to 11.0, preferably between 9.0 and 10.0, in particular to about 9.2.

The second concept may be used individually or as a further embodiment to the concept described above. This concept is based on the unexpected results, that the overall length of such a vehicle may be reduced, probably even minimized, when the axis of the human powered actuator, for example the pedal drive, is arranged in a traverse direction between the two front wheels and when the ratio of the distance of the two front wheels to their diameter is within a certain well defined range. These findings were not to be expected in view of prior art human powered land vehicles, which typically had the axis of the human powered actuator either in front of the front wheels or in between the front wheels and the rear wheel. The dependency of the distance of the front wheels from each other and their diameter governs the size of the space in between the two front wheels in relationship to the total width of the vehicle providing sufficient space between the front wheels to arrange the axis of the human powered actuator. The ratio quoted involves the use of rather small wheels compared to prior art vehicles of the kind, which in turn gives the possibility that in spite of a rather small width of the vehicle and sufficient space in between the two front wheels to allow their steering. This means, that the two front wheels may be turned upon steering action into the usual steering angle still leaves ing sufficient usable space between the two front wheels. In this case the space is used to arrange the axis of the human powered actuator, which in one embodiment is a pedal drive. On the other hand the overall width of the vehicle may be minimized.

With such land vehicle the driver is positioned in the driver's seat preferably in a sitting position. This does not only allow to design such vehicle with a rather short longitudinal extension and with a rather short distance between the axis of the front wheels and the rear wheel, but also allows for comfortable actuation of the human powered actuator, which according to one embodiment of the invention is a feet-driven pedal drive. The muscular energy may then be applied to the pedal drive in an energy saving and thus in an energy efficient mode.

The ratio of the distance of the front wheels from each other in the height of their axis from a ground plane, which ground plane is the plane, the vehicle rests on, and the diameter of the front wheels is preferably in the range from 1.36 to 1.64, and in particular in the range from 1.47 to 1.52.

The height of the axis of the human powered actuator from the ground plane is arranged according to this concept on a higher level than the axis of rotation of the front wheels. The ratio of the height of the axis (A₁, A_{1.1}) of the front wheels (3, 3.1) from the ground plane (G) to the height of the axis (A₃) of the human powered actuator (13) is within the range from 0.50 to 1.00, in particular from 0.64 and 0.66. This enables to use front wheels with a rather small diameter and still have a human powered actuator, for example a pedal drive, of which the levers still have sufficient length in order to conveniently apply muscular force for driving the vehicle.

According to a preferred embodiment, the distance between the axis of rotation of the at least one rear wheel and those of the front wheels is, when projected in the x-y plane, between 1080 mm and 1200 mm, in particular between 1100 mm and 1180 mm.

In another embodiment the rear wheel is arranged to be co-steered with the two front wheels for further enhancement of the handling of such vehicle. This means, that the rear wheel may be also steered upon a steering action to steer the front wheels. Co-steering of the rear wheel allows easier curve handling when riding the vehicle, in particular to make sharper bends. With such concept a given steering angle of the front wheels combined with a co-steered rear wheel results in a smaller radius of curvature to be driven. This again may be used to design the vehicle with a smaller width, because the front wheels in order to achieve a certain radius of curvature when driving may be steered with a smaller steering angle, but still give the same radius of curvature as a vehicle, of which the front wheels are steered with a larger steering angle and having no co-steered rear wheel. This results in more space in width between the two front wheels to be used in the interior of the chassis of such vehicle. Typically such steering action acting on the rear wheel is only a fraction of the steering action applied to the front wheels. The steering action of the rear wheel is typically limited to 10 degrees deviating from the neutral position, in which the rear wheel is unsteered.

Further advantages of the invention will become apparent with the description of an embodiment of the invention with reference to the figures. The figures show:

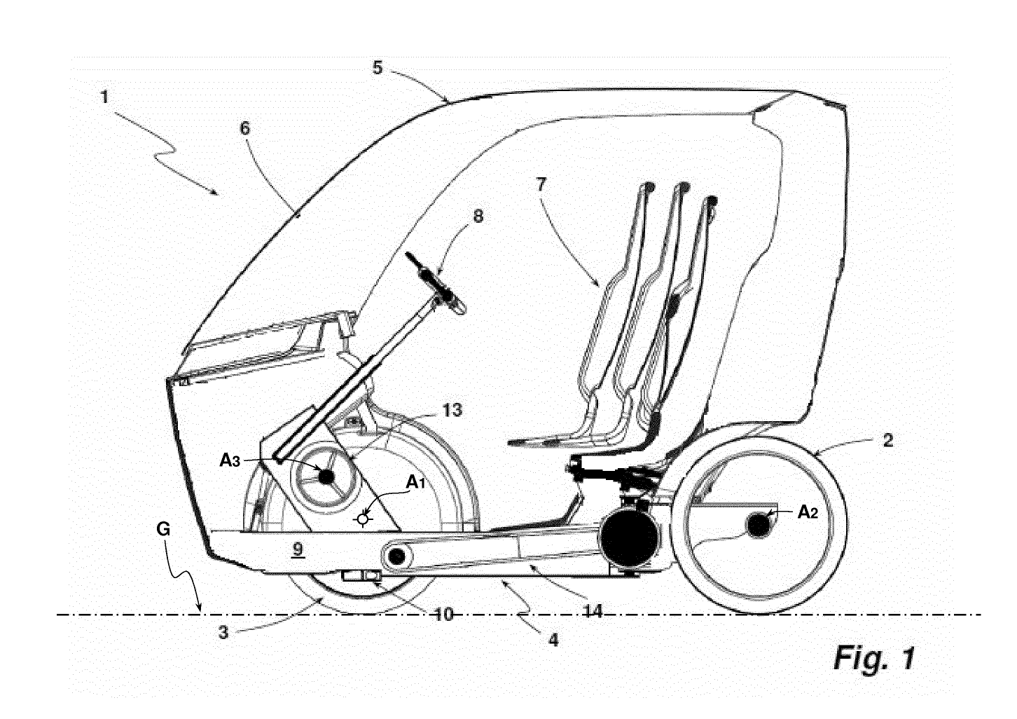

FIG. 1: A schematic side view with parts cut away of a pedal propulsed land vehicle,

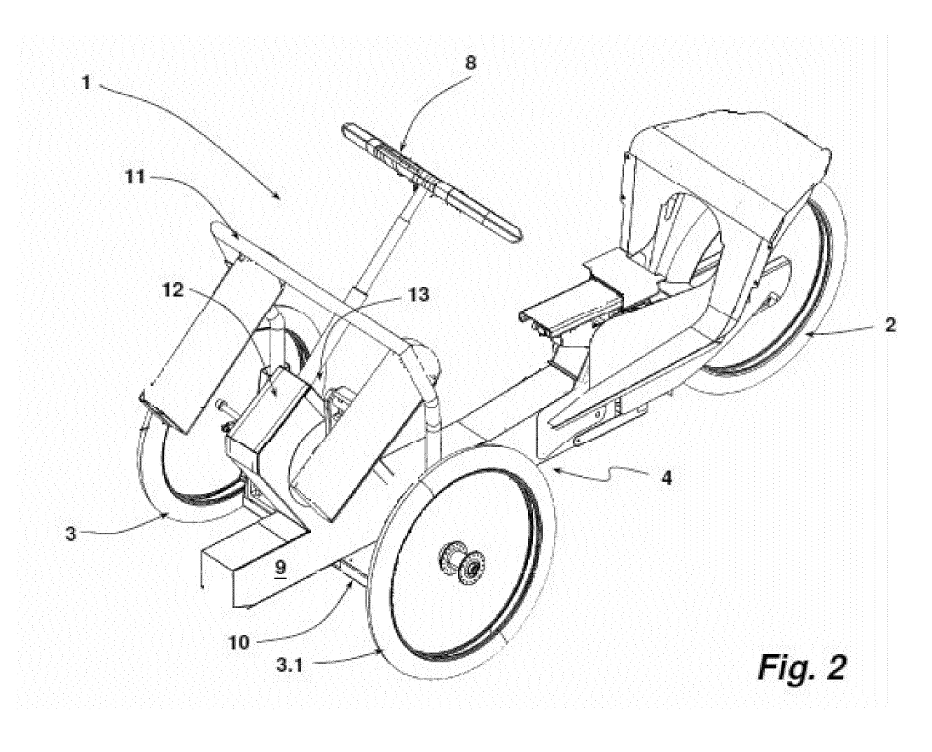

FIG. 2: a perspective view of the chassis of the vehicle of FIG. 1 from a first point of view,

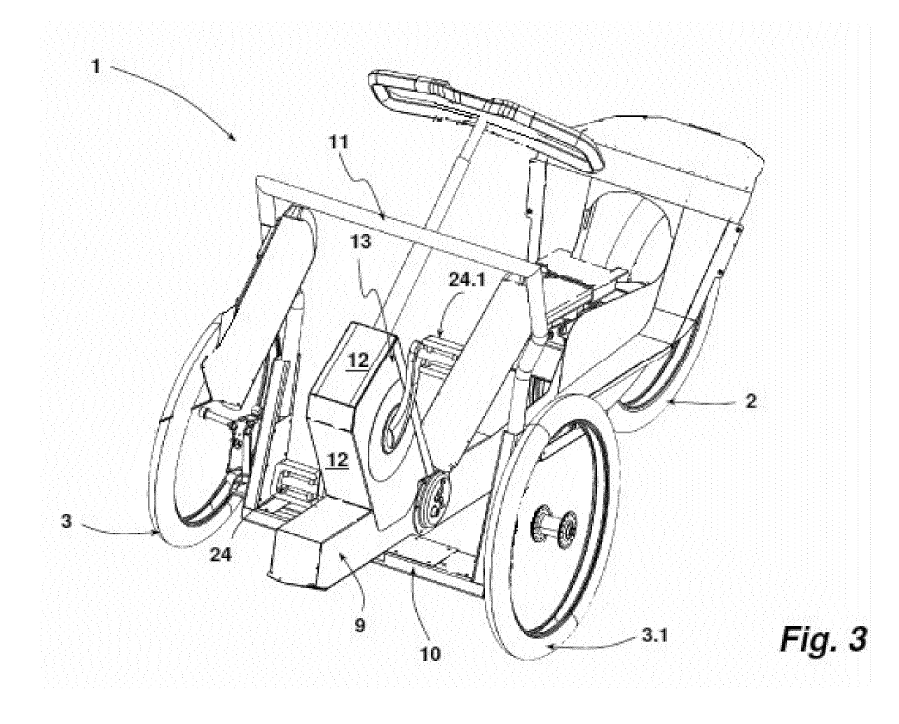

FIG. 3: another perspective view of the chassis of the vehicle depicted in FIG. 1 from another point of view,

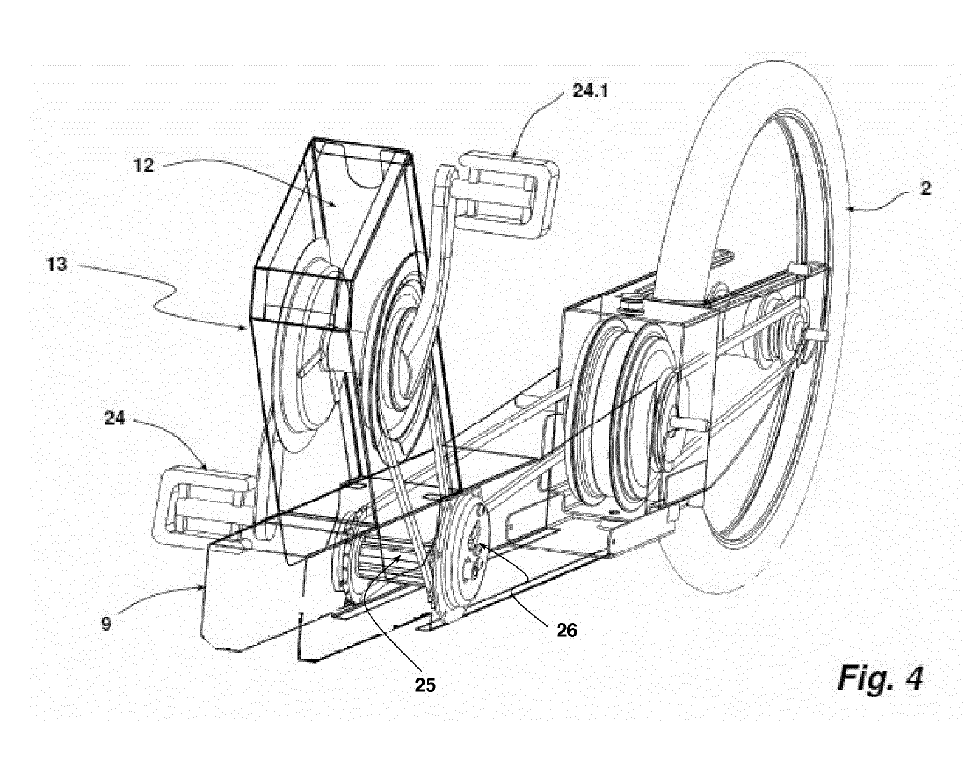

FIG. 4: a close-up of the power train of the vehicle of FIGS. 1 to 3 with the components housing the drive train being depicted in a transparent mode,

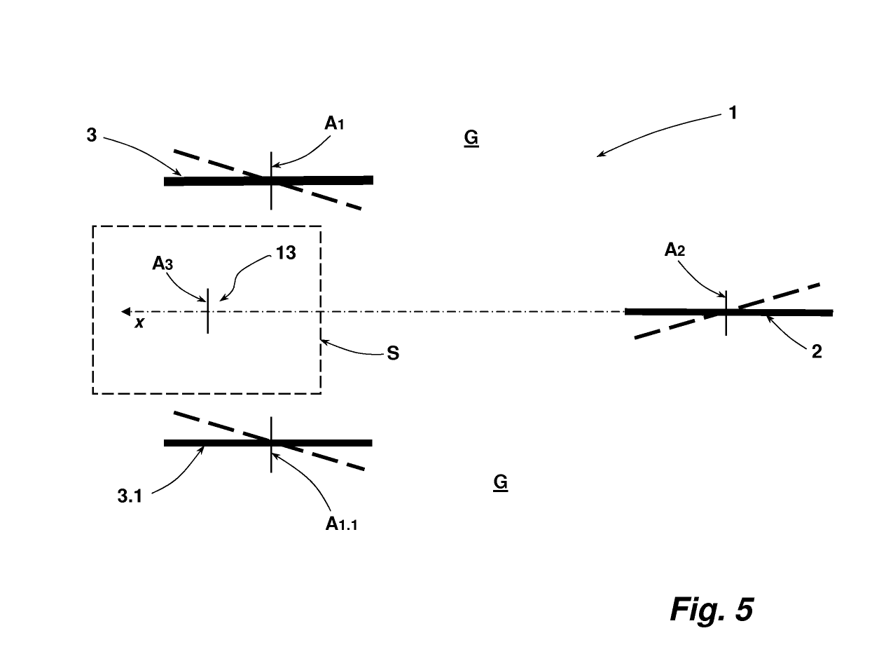

FIG. 5: a schematic top view of the vehicle of FIGS. 1 to 4 visualizing the arrangement of the axis of the wheels and the human powered actuator and

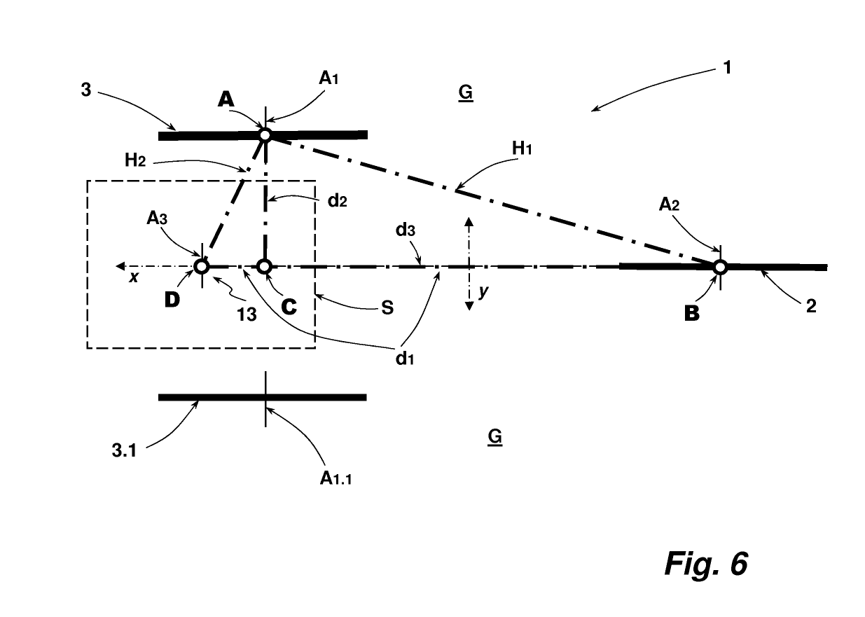

FIG. 6: a schematic top view of the vehicle according to the top view of FIG. 5 visualizing the correlation between the length of the vehicle, its width and location of the pedal axis.

A pedal propulsed land vehicle 1 designed to enhance in particular urban mobility is designed to have three wheels. In the inside side view of FIG. 1 the rear wheel 2 and the right front wheel 3 are to be seen. The wheels 2, 3 are borne on a chassis 4, which will be described later. The chassis 4 is covered by a top cover 5. The cover 5 is manufactured of plastic material, which may be fiber-reinforced. The cover depicted in FIG. 1 covers the chassis 4 as to the front, the top and the back. The right side and the left side are kept open. The front of the cover 5 is translucent. This wind shield part of the cover 5 is identified with reference numeral 6. The backside of the cover 5 incorporates a window. The cover 5 may further comprise fenders to protect the driver from splashing water from the front wheel as possible further features.

The chassis 4 supports a seat 7, which is depicted in FIG. 1 in three of its possible positions. The positions of the seat 7 alter as to their height and the position in respect of the longitudinal extension of the vehicle 1.

The two front wheels 3 of the vehicle 1 are steered. The steering system comprises a steering wheel 8, which is connected in a not depicted manner to a steering gear steering the front wheels 3.

The chassis 4 of the vehicle 1 disposes of a central beam 9 extending in longitudinal direction from the front of the vehicle 1 to the axle of the rear wheel 2. The longitudinal beam 9 is U- or C-shaped in cross-section, with its longitudinal opening facing groundwards. Attached to the beam 9 is a cross-beam 10 extending width-wise to the vehicle. The cross-beam 10 carries the front wheels 3, 3.1 (see FIGS. 2, 3). Mounted on the cross-beam 10 is a mounting bracket 11 linking the bearings of the front wheels 3, 3.1 over the topside of the beam 9.

Mounted on the topside of the beam 9 between the two front wheels 3, 3.1 is a pedal drive housing 12, also bearing a pedal drive 13. The pedal drive 13 is the human powered actuator of the embodiment depicted.

The arrangement of the pedal drive 13 within the housing 12 resting on the topside of beam 9 may better be seen in FIG. 3. FIG. 3 also allows a better view to the cross-beam 10 and the mounting bracket 11. Further, FIG. 3 shows that the front wheels are mounted to have a negative runover.

The vehicle 1 has a power train to drive the rear wheel 2, which power train is in the depicted embodiment divided into three drive train segments 14, 14.1, 14.2. A first drive train segment 14 drives the axle 15 of an electric motor 16 as non-human powered actuator. The axle 15 of the electric motor 16 drives the rear wheel 2 via the second drive train segment 14.1. The driving means of the second drive train segment 14.1 is in the depicted embodiment a chain 17 receiving its movement by rotation of a chain wheel 18 connected to the housing of the electric motor 16. A second chain wheel 19 is arranged on the axle of the rear wheel 2 to receive the driving force. Incorporated into the axle of the rear wheel 2 is a gear hub 20. The driving force received by the chain wheel 19 is transferred through the gear hub 20 and then brings the rear wheel 2 into rotational movement. The gear hub 20 may be actuated by the driver. It is also possible to use an automatic gear shifting device.

The electric motor 16 incorporated into the power train is typically an electric motor, which is well known in the art and is used to drive so called ebikes. With such prior art bikes the electric motor is arranged as the wheel hub of the driven wheel, whereas its axle is fixed to the frame of the bike and the housing of the motor virtually carries the wheel, typically the spokes thereof.

The first drive train segment 14 comprises a chain 21 as driving means driving a chain wheel 22 also sitting on the axle 15 of the electric motor 16. The chain wheel 22 is a free-wheel. Therefore, driving force may only be transferred from the chain 21 to the axle 15 in one direction of rotation. This is the direction for propulsing the vehicle 1 into a forward movement. The first drive train segment 14 is itself driven by a third drive train segment 14.2, which incorporates the pedal drive 13. The driving means of the third drive train segment 14.2 again is a chain 23. The chain 23 is driven by rotating the two pedals 24, 24.1 of the pedal drive 13 around their axle and thus driving a chain wheel, which in turn drives the chain 23. As to be seen in the figures by arrangement of the housing 12 enclosing the third drive train segment 14.2 and the beam 9 enclosing the first drive train segment 14 both drive train segments 14, 14.2 are arranged angular to each other. In the embodiment disclosed both drive train segments 14, 14.2 enclose an obtuse angle. This arrangement allows—which might best be seen in the inside view of the vehicle 1 according to FIG. 1—to arrange the first drive train segment 14 within the beam 9 rather low to the ground but still have the axis of the pedal drive 13 sufficient high for good and efficient pedalling as well as for comfort reasons. Therefore, this arrangement allows having an easy access into the vehicle, thus providing for an easy entering and an easing exiting of the vehicle. The step to be taken is rather low. In particular it may be noted, that inside the vehicle nothing is in the way between the seat 7 and the pedal drive 13. As further to be seen from FIG. 1, the height of the beam 9 is basically arranged below the axis of rotation of the two front wheels 3, 3.1 and the rear wheel 2.

In the interface between the two drive train segments 14.2 and 14, which interface is made by an axle 25 with two chain wheels—one to receive the driving force via the chain 23 and one driving the chain 21 bringing the pedal force onto the axle 15—coupled to axle 25 is a pedal force or torque sensor 26 sensing the strain on the chain 23 driving the axle 25. The sensor 26 senses the applied to chain 23, which in turn is dependent on the muscular force applied to the pedal drive 13. The output of the tension sensor 26 is inputted into a computing device, which in turn actuates the electric motor 16. Depending on the sensed tension of the chain 23 the electric motor 16 is actuated to support propulsion of the vehicle 1. In another embodiment of measuring the pedal power is the use of a torque sensor within the pedal axle.

The electric motor 16 may be actuated in both directions of rotation. In case the vehicle 1 is to be propulsed in reverse motion, then the electric motor 16 will be actuated accordingly. Reversing the vehicle 1 is with the embodiment described not possible using muscular force due to the free wheel 22 on the axle 15 of the electric motor 16. According to another embodiment the free wheel 22, which induces the driving force of the first drive train segment 14 into the second drive train segment 14.1 may be arranged in a manner, that its free wheel state may be blocked. Such blocking of the free wheel state of this wheel may then be utilized to propuls the vehicle with pedal force also backwards. For the locking actuation of this wheel for example electro a magnetic actuating device may be utilized locking the free wheel state of this wheel as long as the actuating device itself is actuated. Such actuating device could be linked with a forward movement sensor, which output signals could be utilized to have this wheel be put back in its free wheel state as soon as a forward motion of the vehicle is detected.

In another embodiment a physical switch in front of the driver is arranged, which enables him to manually choose between the forward and reverse direction of propulsing the vehicle. In yet another embodiment of realizing a switch forward/reverse is the use of a double free wheel that may be arranged in one of the intermediate axles arranged to transfer the power from a first drive train segment to a second drive train segment.

FIG. 5 shows in a schematic top view onto a ground plane G with the locations of the axis of the two front wheels 3, 3.1, the rear wheel 2 and the pedal drive 13. The axis are marked in FIG. 5 with A₁, A_{1.1} for the two front wheels 3, 3.1, with A₂ for the rear wheel 2 and with A₃ for the pedal drive 13. In the schematic top view also the diameter of the front wheels 3, 3.1 and the rear wheel 2 is visualized. The front wheels 3, 3.1 and the rear wheel 2 have in this embodiment the same diameter. The rear wheel 2 and the pedal drive 13 are arranged on the central longitudinal line (x-axis) of the vehicle 1. In the depicted embodiment the distance between the two front wheels 3, 3.1 from the central x-axis is 379 mm. Thus, the distance between the two front wheels 3, 3.1 between their axis is 758 mm. The diameter of the front wheels 3, 3.1 in the depicted embodiment is 508 mm (20″). This results in a ratio of the distance of the front wheels 3, 3.1 measured in the height of their axis A₁, A_{1.1} to their diameter to be 1.46. In FIG. 5 with hedged lines the front wheels 3, 3.1 are also depicted in an inclined position according to a certain steering angle. Between the two front wheels 3, 3.1 a space S, marked by a box is shown. This is the space inside the cabin of the vehicle 1 which is used by the pedal drive 13.

To achieve the benefits of the vehicle 1 with the rather small overall width but still having enough space between the front wheels to arrange the axis of the human powered actuator, the distance between the front wheels should not be less than 650 mm and should not exceed 840 mm. With less width the driving comfort is reduced, because the vehicle is not as stable, in particular in curves or upon side wind action. On the other hand the distance should not be too large, because then negative effects on the handling of the vehicle, for example because of needing a wider space for parking might be encountered.

The diameter of the front wheels should not be smaller than 390 mm (16″) and should not exceed 660 mm (26″). Wheels of smaller size would have negative impact on riding comfort. Larger wheels would in order to allow sufficient turn movement of the front wheels need more space between the front wheels. Then the vehicle would need to be designed with an overall width to be a lot wider.

As best to be seen in the sectional view of FIG. 1 the axis A₃ of the pedal drive 13 is arranged well above (which means in the z-direction of the vehicle) the axis A₁ of the front wheel 3. Further, FIG. 1 visualizes, that the axis A₃ of the pedal drive 13 is arranged in front of the axis A₁ of the front wheel 3 but still between the two front wheels 3, 3.1 in their projection between each other. Of course, the distance between the two front wheels 3, 3.1 is larger than the width of the pedal drive 13 with its pedals.

In the depicted embodiment the distance between the axis A₂ of the rear wheel 2 and the axis A₁, A_{1.1} of the front wheels 3, 3.1 projected in the x-y plane onto the x-axis is 1132 mm. From FIG. 1 it is to be seen, that although the distance of the axis A₂ of the rear wheel 2 and those of the front wheels 3, 3.1 is only a little more than one meter, which enhances by manoeuvrability of the vehicle 1, the vehicle 1 still gives sufficient room within the cover 5 for a driver and even provide for the luggage compartment 34. We belief, that such compact vehicle of the kind has not been suggested before.

In the following the special concept of claim 1 will be described with reference to FIG. 6.

FIG. 6 shows a schematic top view very similar to the top view of FIG. 5 of the vehicle 1. This top view the x-y-plane of the vehicle 1 is to be seen. The specific concept makes use of the symmetric design of the vehicle 1 in respect of its longitudinal axis—the x-axis—. Use of the symmetric design is made in such a way, that in order to specify the teachings only one half of the vehicle 1 needs to be taken into account. This may either be the right side or the left side. In FIG. 6 the right side of vehicle 1 including its longitudinal axis (x-axis) is used to describe the specific geometrical relationships of the arrangement of the different axis A₁, A_{1.1}, A₂ and A₃ and their correlation with each other. Marked in FIG. 6 are the centres of the axis A₁, A₂ and A₃ with A, B and D respectively. These three centres A, B, D define the corners of a triangle. The centres B, D are arranged on the longitudinal axis (x-axis) of the vehicle 1. This triangle A-BD is divided into two triangles, which border to each other, whereas the borderline is the connecting line between the centre A of axis A₁ as a perpendicular line to the x-axis and the intersection therewith, which intersection point is marked with C, thus the line between A and C in FIG. 6. A first triangle—the triangle A-B-C—is the triangle, with which the width of the vehicle 1 as well as it longitudinal extension between the axis A₁, A_{1.1} and A₂ respectively may be expressed. The second triangle—the triangle A-C-D is the triangle describing the arrangement of the human powered actuator—the pedal drive 13 in the depicted embodiment—in respect to the other parts of the vehicle 1, which means in relation to the arrangement of the axis A₁, A_{1.1} of the front wheels 3.3. The line A-C is shared by both triangles A-B-C and A-C-D. Of course, also triangle A-C-D implies information about the width of the vehicle 1.

The axis A₃ of the pedal drive 13 is arranged in front of the projection of the axis A₁, A₂ of the two front wheels 3, 3.1 projected onto the longitudinal axis (x-axis). Being arranged in front is referred to as being in front in the direction of the vehicle 1 in a forward drive. Due to this geometrical arrangement by using the distance of A-B of the first triangle A-B-C and the distance A-D of the second triangle A-C-D, which lines A-B and A-D respectively each are the hypotenuses of the triangles may be used to also express the length between A-C and B-C in respect of triangle A-B-C and A-C and C-D in respect of triangle A-C-D. This is undertaken, if the length of the hypotenusis is squared. As such the theorem of Pythagoras is applied.

Further, three dimensions are defined, which are distances. A first dimension is the distance d₁ between centre B and centre D. The second dimension is the distance d₂ between centre A and intersection point C. The third dimension is the distance d₃ between centre B and intersection point C. These distances d₁, d₂, d₃ are defined by a mean value, whereas distance d₁ is 1235 mm, distance d₂ is 1132 mm and distance d₃ is 379 mm. These mean values may deviate by ±15% at maximum, preferably only by ±10% or even more preferred by only ±5%.

With these requirements as to the distances and the ratio between the squared distance A-B (AB²) and the squared distance A-D (AD²), it was very surprising to encounter, that in such rather simple manner a complex system—here: a human powered vehicle—may be defined meeting the requirements sketched out in the beginning of the specification, which means to construct a human powered land vehicle, which is not only compact but also provides quite some comfort and is easy to handle, but still small in size.

Vehicles that comply with these requirements as said out in the beginning of this specification have a ratio of the squared length of their hypotenusis H₁/H₂ which is in the range between 2.8 and 15.3. Still better results are achieved, if this ratio is in the range between 6.0 to 11.0 and in particular is approximately 9.2.

It is believed, that this is the first time, that such teachings are disclosed to describe the geometry and compactness of a human powered land vehicle is disclosed.

The invention described is particularly aimed at a homologation of a vehicle as defined in “Pedelec 25”, i. e.: An electrically supported bicycle, in which the electric motor is engaged only when the driver is pedalling and the electric power is shut off at a speed above 25 km/h. Except from this are parking conditions, where a pure electric driving is allowable for lower speeds, i. e. up to 5 to 6 km/h.

Reference Numerals

| | |
|---|---|
| 1 | vehicle |
| 2 | rear wheel |
| 3, 3.1 | front wheel |
| 4 | chassis |
| 5 | cover |
| 6 | wind shield |
| 7 | seat |
| 8 | steering wheel |
| 9 | beam |
| 10 | cross-beam |
| 11 | mounting bracket |
| 12 | pedal drive housing |
| 13 | pedal drive |
| 14, 14.1, 14.2 | drive train segment |
| 15 | axle |
| 16 | electric motor |
| 17 | chain |
| 18 | chain wheel |
| 19 | chain wheel |
| 20 | gear hub |
| 21 | chain |
| 22 | chain wheel |
| 23 | chain |
| 24, 24.1 | pedal |
| 25 | axle |
| 26 | torque sensor |
| A | centre of axis A₁ |
| A₁, A_{1.1}, A₂, A₃ | axis of rotation |
| B | centre of axis A₂ |
| C | corner of geometric triangle |
| D | centre of axis A₃ |
| G | ground plane |
| H₁, H₂ | hypotenuse |
| S | space |
| d₁, d₂, d₃ | distance |

1. Human powered land vehicle with two steered front wheels (3, 3.1) and one rear wheel (2) driven by a drive train, which drive train incorporates a human powered actuator (13) to be actuated for propulsion of the vehicle (1) by a person driving the vehicle (1) and cinematically coupled to the rear wheel (2) for propulsing the vehicle (1) in at least one driving direction, characterized,
in that the axis (A₃) of the human powered actuator (13) is arranged in the longitudinal extension of the vehicle (1) in front of the axis (A₁, A_{1.1}) of rotation of the front wheels (3, 3.1),
in that three dimensions are defined in the x-y plane of the vehicle, which are
(a) a distance d₁ between the centre (B) of rotation of the axis (A₂) of the rear wheel (2) and the centre (D) of rotation of the axis (A₃) of the human powered actuator (13),
(b) a distance d₂ between the centre (A) of rotation of the axis (A₁, A_{1.1}) of the front wheel (3, 3.1) and the intersection point (C) of a line connecting the centre (A) with the x-axis of the vehicle (1) the connecting line being perpendicular to the x-axis of the vehicle (1), and
(c) a distance d₃ between the centre (B) and the intersection point (C), whereas distance d₁ has a value of 1235 mm±15%, distance d₂ has a value of 1132 mm±15%, and distance d₃ has a value of 379 mm±15% and
in that the ratio between the squared distance (AB²) between the centre (B) and the centre (A) and the squared distance (AD²) between the centre (A) and the centre (D) is within the range between 2.8 to 15.3.

2. Vehicle according to claim 1, characterized, in that the ratio is within the range between 6.0 to 11.0.

3. Vehicle according to claim 2, characterized, in that the range is between 9.0 and 10.0, in particular 9.2.

4. Human powered land vehicle with two steered front wheels (3, 3.1) and at least one rear wheel (2) driven by a drive train, which drive train incorporates a human powered actuator (13) to be actuated for propulsion of the vehicle (1) by a person driving the vehicle (1) and cinematically coupled to the rear wheel (2) for propulsing the vehicle (1) in at least one driving direction, in particular according to one of claims 1 to 3, characterized, in that the ratio of the distance of the front wheels (3, 3.1) from each other measured in the height of their axis (A₁, A_{1.1}) of rotation and the diameter of the front wheels (3, 3.1) is in the range from about 1.1 to about 1.9 and in that the axis (A₃) of the human powered actuator (13) is arranged between the two front wheels (3, 3.1) within their projection to each other in the traverse direction of the vehicle (1) and in the vertical direction above the axis (A₁, A_{1.1}) of rotation of the front wheels (3, 3.1) and in the longitudinal extension of the vehicle (1) in front of the axis (A₁, A_{1.1}) of rotation of the front wheels (3, 3.1).

5. Vehicle according to claim 4, characterized, in that the ratio of the distance of the front wheels (3, 3.1) from each other measured in the height of their axis (A₁, A_{1.1}) of rotation and the diameter of the front wheels (3, 3.1) is in the range from 1.36 to 1.64, in particular from 1.47 to 1.52.

6. Vehicle according to claim 4 or 5, characterized, in that the ratio of the height of the axis (A₁, A_{1.1}) of the front wheels (3, 3.1) from the ground plane (G) to the height of the axis (A₃) of the human powered actuator (13) is within the range from 0.50 to 1.00, in particular from 0.64 and 0.66.

7. Vehicle according to one of claims 1 to 6, characterized, in that, when projected in the x-y plane, the distance between the axis (A₂) of rotation of the one rear wheel (2) and those of the two front wheels (3, 3.1) onto a central longitudinal axis (x-axis) is between 1080 mm and 1200 mm, in particular between 1100 mm and 1180 mm.

8. Vehicle according to one of claims 1 to 7, characterized, in that the human powered actuator is a feet-driven pedal drive (13).

9. Vehicle according to one of claims 1 to 8, characterized, in that the vehicle (1) disposes of a driver's seat (7) designed that the person when driving the vehicle (1) is in a sitting position.

10. Vehicle according to one of claims 1 to 9, characterized, in that the rear wheel is linked to the steering system of the front wheels, allowing the rear wheel to be steered by a steering action in the opposite direction to the front wheels.

11. Vehicle according to claim 10, characterized, in that the amount of the steerability of the rear wheel is limited to 10 degrees in each direction departing from the neutral position.

12. Vehicle according to one of claims 1 to 11, characterized, in that the drive train disposes of a non-human powered actuator (16) arranged to drive at least one of the wheels.

13. Vehicle according to claim 12, characterized, in that the non-human powered actuator (16) is arranged to drive the rear wheel (2) and is arranged in an in-line arrangement in the drive train driving the vehicle (1) and being actuated by the human powered actuator (13).
